(19) United States
(12) Patent Application Publication
(10) Pub. No.: US 2026/0081163 A1
(43) Pub. Date: Mar. 19, 2026

(54) NON-AQUEOUS ELECTROLYTE SECONDARY BATTERY

(71) Applicant: Panasonic Energy Co., Ltd., Moriguchi-shi, Osaka (JP)

(72) Inventors: Junichi Fujishige, Tokushima Ken (JP); Takamitsu Tashita, Tokushima Ken (JP); Akihiro Katogi, Osaka Fu (JP); Sachiyo Kaneko, Tokushima Ken (JP)

(73) Assignee: Panasonic Energy Co., Ltd., Moriguchi-shi, Osaka (JP)

(21) Appl. No.: 19/106,342

(22) PCT Filed: Jul. 21, 2023
(86) PCT No.: PCT/JP2023/026789

§ 371 Date: Feb. 25, 2025

(30) Foreign Application Priority Data
Aug. 31, 2022 (JP) 2022-137562

(51) Int. Cl. H01M 4/62; H01M 4/04; H01M 10/04

(52) U.S. Cl. CPC H01M 4/622; H01M 4/0404; H01M 4/043; H01M 10/049

(57) ABSTRACT

A nonaqueous electrolyte secondary battery includes a positive electrode, a negative electrode, a separator provided between the positive electrode and the negative electrode, and a nonaqueous electrolyte. The negative electrode includes a negative electrode current collector and a negative electrode mixture layer formed on a surface of the negative electrode current collector. The negative electrode mixture layer contains a negative electrode active material, a first binder, and an isothiazolin-based compound. The first binder is a carboxymethylcellulose compound. The proportion of the mass of the isothiazolin-based compound in the negative electrode mixture layer to the mass of the negative electrode mixture layer is 20 ppm or more and 2000 ppm or less. With the above configuration, permeability of the nonaqueous electrolyte into the negative electrode mixture layer can be increased.

### TECHNICAL FIELD

The present disclosure relates to a nonaqueous electrolyte secondary battery.

### BACKGROUND OF THE INVENTION

Patent Literature 1 proposes “a lithium-ion secondary battery including: a negative electrode including a negative electrode active material layer containing a negative electrode active material and a negative electrode binder; a positive electrode including a positive electrode active material layer containing a positive electrode active material and a positive electrode binder; an electrolyte solution; and a separator, wherein the negative electrode active material is constituted by a carbonaceous active material, the negative electrode binder is a polymer polymerized from a negative electrode monomer composition, the negative electrode monomer composition contains, in 100 parts by mass thereof. 70 to 90 parts by mass of a styrene monomer and 1 to 5 parts by mass of ethylene-based unsaturated carbonic acid monomer, the proportion of the negative electrode binder to 100 parts by mass of the negative electrode active material in the negative electrode active material layer is 0.1 to 5 parts by mass, the positive electrode active material contains at least one transition metal element selected from the group consisting of manganese, iron, and nickel, the proportion of the positive electrode binder to 100 parts by mass of the positive electrode active material in the positive electrode active material layer is 0.1 to 5 parts by mass, the positive electrode binder is a polymer polymerized from a positive electrode monomer composition, the positive electrode monomer composition contains, in 100 parts by mass thereof. 10 to 35 parts by mass of an acrylonitrile monomer and 1 to 10 parts by mass of an ethylene-based unsaturated carbonic acid monomer, and the positive electrode binder is a polymer having a degree of swelling in the electrolyte of 2.0 to 15.0 times.”

Patent Literature 2 proposes “a binder composition for secondary battery negative electrode use containing a binder, an α-methylstyrene dimer, and an amine-based compound. The binder is constituted by 25 to 55% by mass of an aliphatic conjugated diene-based monomer unit, 1 to 10% by mass of an ethylene-based unsaturated carbonic acid monomer unit, and 35 to 74% by mass of another monomer unit that is co-polymerizable therewith. Relative to 100 parts by mass of the binder, the amount of the α-methylstyrene dimer is more than 3000 ppm and less than 7000 ppm and the amount of the amine-based compounds is 100 to 5000 ppm.”

Patent Literatures 1 and 2 respectively disclose that the proposed negative electrode monomer composition and the proposed binder composition for negative electrode use may contain a benzoisothiazolin-based compound as a preservative.

### CITATION LIST

### Patent Literature

[Patent Literature 1] International Publication No. WO2011/122297
[Patent Literature 2] International Publication No. WO2012/026462

### SUMMARY OF INVENTION

### Technical Problem

In recent years, there has been an increasing demand for improvements on added values of rapid charge and discharge performance of nonaqueous electrolyte secondary batteries used as motive power sources for in-vehicle use or for electric motors and electric storage systems, for example. One approach to the demand such as above is to increase permeability of a nonaqueous electrolyte into a negative electrode mixture layer.

A negative electrode mixture constituting the negative electrode mixture layer contains a binder. A carboxymethylcellulose compound (hereinafter also referred to as “CMC compound”) generally used as a binder has an action of imparting stable viscosity to a negative electrode slurry and fixing the negative electrode active material to a negative electrode current collector. By contrast, the CMC compound, which is an insulating component, can hinder improvement of rapid charge and discharge performance.

The carboxymethylcellulose compound (CMC compound) is a generic term for carboxymethylcellulose (hereinafter also referred to as “CMC”) and carboxymethylcellulose salt (hereinafter also referred to as “CMC salt”).

It is also conceivable to reduce the content of the CMC compound in the negative electrode mixture. However, when reducing the amount of the CMC compound, viscosity of the negative electrode slurry may become unstable, or adhesiveness between the negative electrode mixture and the negative electrode current collector may decrease. This is disadvantageous for charge and discharge cycle performance. Therefore, the demand for higher performance cannot be fully met.

### Solution to Problem

One aspect of the present disclosure relates to a nonaqueous electrolyte secondary battery including a positive electrode, a negative electrode, a separator interposed between the positive electrode and the negative electrode, and a nonaqueous electrolyte, wherein the negative electrode includes a negative electrode current collector and a negative electrode mixture layer formed on a surface of the negative electrode current collector, the negative electrode mixture layer contains a negative electrode active material, a first binder, and an isothiazolin-based compound, the first binder is a carboxymethylcellulose compound, and a proportion of a mass of the isothiazolin-based compound in the negative electrode mixture layer to a mass of the negative electrode mixture layer is 20 ppm or more and 2000 ppm or less.

Another aspect of the present disclosure includes a method of producing a nonaqueous electrolyte secondary battery including: a step of preparing a positive electrode; a step of preparing a negative electrode; a step of preparing a separator; a step of preparing a nonaqueous electrolyte; a step of forming an electrode body with the positive electrode, the negative electrode, and the separator, and a step of accommodating the electrode body and the nonaqueous electrolyte in a battery case, wherein the step of preparing a negative electrode includes: a step of preparing a negative electrode slurry by mixing a negative electrode mixture and water, and a step of forming a negative electrode mixture layer by applying the negative electrode slurry to a surface of a negative electrode current collector to form a coating film, followed by drying the coating film and compressing the coating film, the negative electrode mixture contains a negative electrode active material, a first binder, and an isothiazolin-based compound, and the first binder is a carboxymethylcellulose compound (CMC compound).

### Advantageous Effects of Invention

As a result of formation of the negative electrode mixture layer with a negative electrode slurry containing an isothiazolin-based compound, permeability of the nonaqueous electrolyte into the negative electrode mixture layer is increased.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1(a) is a conceptual diagram illustrating a state in a negative electrode mixture layer included in a conventional negative electrode, and (b) is a conceptual diagram illustrating a state in a negative electrode mixture layer included in a negative electrode according to the present disclosure.

FIG. 2 is a partially cut-away perspective view of a nonaqueous electrolyte secondary battery according to an embodiment of the present disclosure.

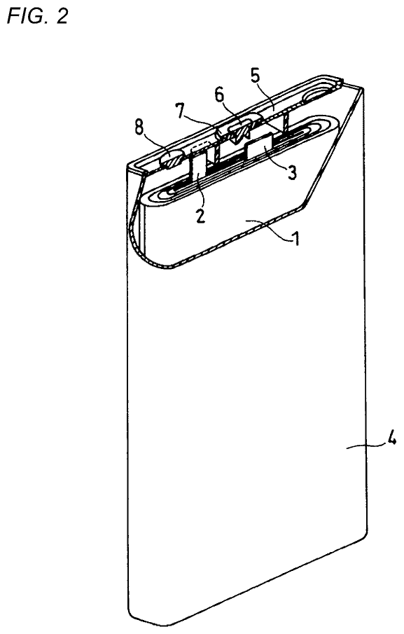

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be phrased as “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one type of them may be selected and used alone, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

In the following description, the word “comprise” or “include” is an expression including meanings of “comprise (or include)”, “essentially consist of”, and “consist of”.

A nonaqueous electrolyte secondary battery according to the present disclosure includes a positive electrode, a negative electrode, a separator provided between the positive electrode and the negative electrode, and a nonaqueous electrolyte. The nonaqueous electrolyte secondary battery includes at least a lithium-ion secondary battery.

### (Negative Electrode)

The negative electrode includes a negative electrode current collector and a negative electrode mixture layer formed on a surface of the negative electrode current collector. The negative electrode mixture layer is carried on one or both surfaces of the negative electrode current collector. The negative electrode mixture layer is in the form of a layer or a film

The negative electrode current collector is constituted by a sheet-shaped conductive material. As the negative electrode current collector, a non-perforated conductive substrate or a metal foil may be used, for example. Alternatively, a perforated conductive substrate (a mesh, a net, or a punched sheet) may be used. Examples of the material of the negative electrode current collector include stainless steel, nickel, nickel alloys, copper, and copper alloys. The thickness of the negative electrode current collector is, for example, 1 to 50 μm, and may be 5 to 30 μm.

The negative electrode mixture layer is constituted by a negative electrode mixture containing a negative electrode active material as a main component, and may be referred to as a negative electrode active material layer. The negative electrode mixture layer contains a negative electrode active material, a first binder, and an isothiazolin-based compound. The first binder is a carboxymethylcellulose compound (CMC compound). The CMC compound is a generic term for carboxymethylcellulose (CMC) and carboxymethylcellulose salt (CMC). The CMC salt is not particularly limited and may include Na salts, lithium salts, and ammonium salts, for example.

The isothiazolin-based compound has an isothiazolin ring and are used, for example, as an antibacterial agent or a preservatives in cosmetics, household products, and the like. However, the isothiazolin-based compound in the present disclosure is contained in a negative electrode slurry prepared to form the negative electrode mixture layer. In the negative electrode slurry containing a predetermined amount of the isothiazolin-based compound, the dispersion state of the CMC compound and the negative electrode active material differs from that in the negative electrode slurry containing less than a predetermined amount of an isothiazolin-based compound Specifically, dispersibility of the CMC compound becomes moderately nonuniform to change the coating condition of the CMC compound covering the negative electrode active material, thereby increasing permeability of the nonaqueous electrolyte into the negative electrode mixture layer. Thus, rapid charge and discharge performance is also improved.

When the isothiazolin-based compound is contained in the negative electrode slurry so that the proportion of the mass of the isothiazolin-based compound in the negative electrode mixture layer to the mass of the negative electrode mixture layer (hereinafter, also referred to as the “mass content of the isothiazolin-based compound in the negative electrode mixture layer”) is 20 ppm or more and 2000 ppm or less, permeability of the nonaqueous electrolyte into the negative electrode mixture layer can be increased. The mass content of the isothiazolin-based compound in the negative electrode mixture layer may be 50 ppm or more, or may be 100 ppm or more. The mass content of the isothiazolin-based compound in the negative electrode mixture layer may be 1000 ppm or less, or may be 500 ppm or less. One preferred example of the mass content of the isothiazolin-based compound in the negative electrode mixture layer is 100 ppm or more and 1000 ppm or less.

When the proportion of the mass of the isothiazolin-based compound in the negative electrode mixture layer to the mass of the negative electrode mixture layer is less than 20 ppm, the CMC compound adheres to the surface of the negative electrode active material uniformly to some extent. Accordingly, a larger part of the surface of the negative electrode active material is covered with the CMC compound. When the proportion of the mass of the isothiazolin-based compound in the negative electrode mixture layer to the mass of the negative electrode mixture layer exceeds 2000 ppm, the dispersion state of the CMC compound becomes excessively nonuniform to decrease adhesiveness between the negative electrode mixture layer and the negative electrode current collector.

The isothiazolin-based compound in the negative electrode mixture layer can be analyzed by the following method, for example. First, the negative electrode is taken out of a battery, and the taken-out negative electrode is washed with a solvent such as dimethyl carbonate (DMC), and then dried at 60° C. The negative electrode mixture layer is scraped from the negative electrode using a spatula. Approximately 0.5 g of powder of the scraped negative electrode mixture is weighed and put into a screw-top bottle. The screw-top bottle is charged with 5 mL of acetone, and placed in an ultrasonic cleaner for 1 hour. The screw-top bottle was taken out and left to stand at room temperature for at least one night. The supernatant liquid in the screw-top bottle was collected and analyzed using a GC-MS device. In qualitative analysis, the above measurement is performed after the peak position (time) of GC-MS is checked in advance using an isothiazolin-based compound reagent. In quantitative measurement, the above measurement is performed after a calibration curve of the peak-intensity area of GC-MS is plotted in advance using an isothiazolin-based compound reagent.

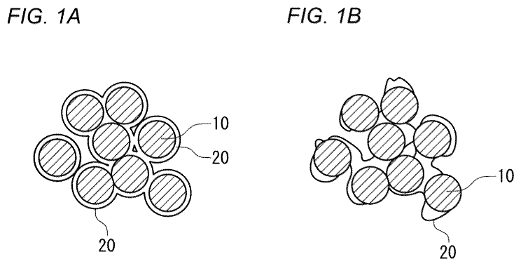

FIG. 1(a) is a conceptual diagram illustrating a state in a negative electrode mixture layer included in a conventional negative electrode. FIG. 1(b) is a conceptual diagram illustrating a state in the negative electrode mixture layer included in the negative electrode according to the present disclosure. In FIG. 1(a), many areas of the surfaces of negative electrode active material particles 10 are covered with film of a CMC compound 20 uniformly to a certain extent, and the nonaqueous electrolyte tends to be hindered in its ability to permeate the negative electrode active material particles 10. On the other hand, in FIG. 1(b), the thickness of the CMC compound 20 adhering to the surfaces of the negative electrode active material particles 10 is non-uniform, and many areas not covered with the CMC compound 20 are left on the surfaces of the negative electrode active material particles 10. As such, permeation of the nonaqueous electrolyte into the negative electrode active material particles 10 is easy to proceed.

The isothiazolin-based compound is a compound having a five-membered ring having one nitrogen atom and one sulfur atom, and is at least one selected from the group of compounds containing isothiazolinon in which a carbon atom constituting the five-membered ring forms a carbonyl group. One isothiazolin-based compound may be used alone, or two or more isothiazolin-based compounds may be used in combination.

Specifically, the isothiazolin-based compound may be at least one selected from the group consisting of 5-chloro-2-methyl-4-isothiazolin-3-one, 2-methyl-4-isothiazolin-3-one, 2-n-octyl-4-isothiazolin-3-one, 4,5-dichloro-2-n-octyl-4-isothiazolin-3-one, 2-ethyl-4-isothiazolin-3-one, 4,5-dichloro-2-cyclohexyl-4-isothiazolin-3-one, 5-chloro-2-ethyl-4-isothiazolin-3-one. 5-chloro-2-t-octyl-4-isothiazolin-3-one, and 1,2-benzothiazolin-3-one.

The proportion of the mass of the CMC compound in the negative electrode mixture layer to the mass of the negative electrode mixture layer (hereinafter, also referred to as the “mass content of the CMC compound in the negative electrode mixture layer”) is, for example, 0.2% by mass or more and 5.0% by mass or less, and may be 0.2 to 4.0% by mass, or may be 0.2 to 3.0% by mass. Within the above range, stable viscosity can be imparted to the negative electrode slurry, and an action of firmly fixing the negative electrode active material (negative electrode mixture layer) to the negative electrode current collector is sufficiently exhibited. In addition, permeability of the nonaqueous electrolyte into the negative electrode mixture layer is also favorably maintained.

The negative electrode mixture layer may contain a second binder different from the first binder. As the second binder, any material conventionally known as a binder for negative electrodes of nonaqueous electrolyte secondary batteries can be used without any particular limitation. Specific examples of the second binder include fluorocarbon resins (e.g., polytetrafluoroethylene and polyvinylidene fluoride), polyolefin resins (e.g., polyethylene and polypropylene), polyamide resins (e.g., aramid resin), polyimide resins (e.g., polyimide and polyamideimide), acrylic resins (e.g., polyacrylic acid, polymethacrylic acid, acrylic acid-methacrylic acid copolymers, ethylene-acrylic acid copolymers, and salts of these), vinyl resins (e.g., polyvinyl acetate), and rubber-like materials (e.g., styrene-butadiene copolymer rubber (SBR)). One binder may be used alone, or two or more binders may be used in combination.

The proportion of the mass of the second binder in the negative electrode mixture layer to the mass of the negative electrode mixture layer (hereinafter, also referred to as “mass content of the second binder in the negative electrode mixture layer”) is, for example, 10.0% by mass or less, and may be 0.1 to 5.0% by mass, or may be 0.1 to 3.0% by mass. Within the above range, the action of firmly fixing the negative electrode active material (negative electrode mixture layer) to the negative electrode current collector is sufficiently exhibited. In addition, permeability of the nonaqueous electrolyte into the negative electrode mixture layer is also favorably maintained.

The second binder may contain a trace amount of an isothiazolin-based compound. However, the amount of the isothiazolin-based compound derived from the second binder mixed in the negative electrode mixture layer is scarce. The mass content of the isothiazolin-based compound in the negative electrode mixture layer cannot be set to be 20 ppm or more only by using the isothiazolin-based compound derived from the second binder. Therefore, it is necessary to mix a predetermined amount of the isothiazolin-based compound in the negative electrode slurry.

The following describes next an example of a method of producing the nonaqueous electrolyte secondary battery according to the present disclosure.

The nonaqueous electrolyte secondary battery according to the present disclosure includes a step of preparing a positive electrode, a step of preparing a negative electrode, a step of preparing a separator, a step of preparing a nonaqueous electrolyte, a step of forming an electrode body with the positive electrode, the negative electrode, and the separator, and a step of accommodating the electrode body and the nonaqueous electrolyte in a battery case.

The step of preparing a negative electrode includes a step of preparing a negative electrode slurry by mixing a negative electrode mixture with water, and a step of forming a negative electrode mixture layer by applying the negative electrode slurry to a surface of a negative electrode current collector to form a coating film, followed by drying and compressing the coating film. The negative electrode mixture contains a negative electrode active material, a carboxymethylcellulose compound being a first binder, and an isothiazolin-based compound.

The dispersion medium for dispersing the negative electrode mixture is not limited to water, and may be any of alcohols (e.g., ethanol), ethers (e.g., tetrahydrofuran), amides (e.g., dimethylformamide), N-methyl-2-pyrrolidone (NMP), and mixed solvents of these.

The proportion of the mass of the isothiazolin-based compound in the negative electrode slurry to the mass of the negative electrode slurry (hereinafter, also referred to as “mass content of the isothiazolin-based compound in the negative electrode slurry”) may be 10 ppm or more and 1000 ppm or less. As a result of the isothiazolin-based compound being contained in the negative electrode slurry within the above range, dispersibility of the CMC compound becomes moderately nonuniform to differ the coating condition of the CMC compound on the negative electrode active material, thereby increasing permeability of the nonaqueous electrolyte into the resulting negative electrode mixture layer. The mass content of the isothiazolin-based compound in the negative electrode slurry may be 25 ppm or more, or may be 50 ppm or more. The mass content of the isothiazolin-based compound in the negative electrode slurry may be 500 ppm or less, or may be 250 ppm or less. A preferable example of the mass content of the isothiazolin-based compound in the negative electrode slurry is 50 ppm or more and 500 ppm or less.

The negative electrode active material will be described next. Examples of the negative electrode active material include a carbonaceous material, an Si-containing material, and an Sn-containing material. The Si-containing material may be Si alone, an Si alloy, or an Si compound (such as Si oxide), for example, or may be a composite material including a lithium-ion conducting phase and silicon phases dispersed in the lithium-ion conducting phase. Examples of the Su-containing material include Sn alone. Sn alloys, and Sn compounds (such as Sn oxides).

The volume of the Si-containing material expands and contracts with charging and discharging. As such, when the ratio of the material to the negative electrode active material increases, contact failure between the negative electrode active material and the negative electrode current collector tends to occur with charging and discharging. The carbonaceous material has a smaller degree of expansion and contraction during charging and discharging than the Si-containing material. When the Si-containing material and the carbonaceous material are used in combination, contact between the negative electrode active material particles and contact between the negative electrode mixture and the negative electrode current collector can be kept in good condition when charging and discharging are repeated. Therefore, combinational use of the Si-containing material and the carbonaceous material containing no Si phase enables easy achievement of excellent cycle characteristics while providing the negative electrode with high capacity of the Si phases.

The composite material including a lithium-ion conductive phase and silicon phases dispersed in the lithium-ion conductive phase may form a sea-island structure in which minute silicon phases are dispersed in the lithium-ion conductive phase (matrix). Use of the Si-containing material such as above can achieve high capacity and suppress degradation of cycle characteristics.

Examples of the carbonaceous material include graphite, graphitizable carbon (soft carbon), and non-graphitizable carbon (hard carbon). As the carbonaceous material, one carbonaceous material may be used alone, or two or more carbonaceous materials may be used in combination.

Among these, graphite is preferable as the carbonaceous material because of its excellent charge and discharge stability and low irreversible capacity. Examples of the graphite include natural graphite, artificial graphite, and graphitized mesophase carbon particles. The graphite particles may contain, in part, amorphous carbon, graphitizable carbon, and non-graphitizable carbon.

The graphite is a carbonaceous material in which a graphite-type crystal structure has been developed. The average spacing d002 of the (002) plane of graphite measured by X-ray diffractometry may be, for example, 0.340 nm or less, or may be 0.3354 nm or more and 0.340 nm of less. The crystallite size Lc (002) of the graphite may be, for example, 5 nm or more, and may be 5 nm or more and 200 nm or less. The crystallite size Lc (002) is measured by Scherrer method, for example. When the average spacing d002 of the (002) plane and the crystallite size Lc (002) of the graphite are within the above ranges, high capacity tends to be obtained

The rate of the total amount of the Si-containing material and the carbonaceous material (carbonaceous material containing no Si phase) in the negative electrode active material is preferably 90% by mass or more, and may be 95% by mass or more, or 98% by mass or more. The rate of the total amount of the Si-containing material and the carbonaceous material in the negative electrode active material is 100% by mass or less. The negative electrode active material may be constituted by only at least one of the Si-containing material and the carbonaceous material.

As the composite material including a lithium-ion conductive phase and silicon phases dispersed in the lithium-ion conductive phase, carbon composite particles including a carbon phase and Si phases dispersed in the carbon phase may be used. Since the carbon phase has electronic conductivity, the carbon composite particles are hardly isolated, and the contact points between the carbon composite particles and their surroundings are easily maintained, even if cracking occurs in the carbon composite particles due to expansion and contraction of the Si phases. Therefore, degradation of cycle characteristics is easily suppressed.

The carbon phase may be constituted by non-crystalline carbon (i.e., amorphous carbon), or crystalline carbon, for example. The amorphous carbon may be hard carbon, soft carbon, or any other carbon, for example. Amorphous carbon generally refers to a carbonaceous material having an average spacing d002 of the (002) plane measured by X-ray diffractometry of larger than 0.340 nm. Examples of the crystalline carbon include carbon having a graphite-type crystal structure, such as graphite. Crystalline carbon such as graphite refers to a carbonaceous material having a d002 of 0.340 nm or less (e.g., 0.3354 nm or more and 0.340 nm or less).

The content of the Si phases in the carbon composite particles is, for example, 30% by mass or more and 80% by mass or less, and may be 40% by mass or more and 70% by mass or less. Within the range such as above, higher initial capacity can be obtained, and degradation of cycle characteristics can be easily suppressed. Further, as a result of inclusion of a relatively large amount of the carbon phase, the carbon phase easily enters voids formed and conductive paths in the negative electrode mixture are easily maintained even if cracking occurs in the particles due to charging and discharging.

The content of the carbon composite particles in the negative electrode active material is, for example, 3% by mass or more, and may be 4% by mass or more, or 5% by mass or more. When the content of the carbon composite particles is within the range such as above, influence of side reactions of the newly produced surface is likely to emerge due to volume change associated with absorption and release of lithium ions. Therefore, effects of using the nonaqueous electrolyte containing the S-containing cyclic component are likely to clearly observed. In view of ensuring excellent cycle characteristics, the content of the carbon composite particles in the negative electrode active material is 10% by mass or less, for example.

The carbon composite particles can be obtained, for example, by pulverizing a mixture of a carbon source and a raw material silicon under stirring using a ball mill or the like for micronization, followed by heat treatment of the mixture in an inert atmosphere. Examples of the carbon source include: petroleum resins such as coal pitch, petroleum pitch, and tar; saccharides such as carboxymethylcellulose (CMC), polyvinylpyrrolidone, cellulose, and sucrose; and water-soluble resins. In mixing the carbon source and the raw material silicon, for example, the carbon source and the raw material silicon may be dispersed in a dispersion medium such as alcohol. After the milled mixture is dried, the mixture is heated at, for example, 600° C. or higher and 1000° C. or lower in an inert gas atmosphere to carbonize the carbon source, thereby forming the carbon phase.

The lithium-ion conducting phase may include at least one selected from the group consisting of an SiO₂ phase and a silicate phase. That is, the composite material may form composite particles including an SiO₂ phase and silicon phases dispersed in the SiO₂ phase, or composite particles including a silicate phase and silicon phases dispersed in the silicate phase.

The SiO₂ phase is an amorphous phase containing 95% by mass or more of silicon dioxide. The composite particles in which the Si phases are dispersed in the SiO₂ phase are represented by SiOₓ. For example, x satisfies the condition of 0.5≤x<2, and may satisfy the condition of 0.8≤x≤1.6. SiOₓ is obtained, for example, by heat treatment of silicon monoxide, followed by disproportionation reaction and separation of the resulting substance into an SiO₂ phase and fine Si phases.

The silicate phase preferably contains at least one of an alkali metal element (a Group 1 element other than hydrogen in the long-period periodic table) and a Group 2 element in the long-period periodic table. Examples of the alkali metal element include lithium (Li), potassium (K), and sodium (Na). Examples of the group 2 element include magnesium (Mg), calcium (Ca), strontium (Sr), and barium (Ba). The lithium silicate phase may have a composition represented by formula: Li_{2y}SiO_{2+y}(0<y<2), y may be ½ or 1. The silicate composite particles in which the Si phases are dispersed in the silicate phase can be obtained, for example, by pulverizing a mixture of silicate and raw material silicon under stirring using a ball mill or the like for micronization, followed by heat treatment of the resulting mixture in an inert atmosphere.

The content of the Si phases dispersed in the silicate phase may be 30% by mass or more and 95% by mass or less relative to the entirety of the composite particles, and may be 35% by mass or more and 75% by mass or less.

In view of increasing conductivity, at least parts of the surfaces of the particles of the Si-containing material may be coated with conductive layers. The conductive layers contain a conductive material such as conductive carbon. The coating amount of the conductive layers is, for example, 1 part by mass or more and 10 parts by mass or less per 100 parts by mass of the sum of the particles of the Si-containing material and the conductive layers. The particles of the Si-containing material with the conductive layers thereon are obtained, for example, by mixing coal pitch or the like with the particles of the Si-containing material, followed by heat treatment in an inert atmosphere.

The content of the Si-containing material in the negative electrode active material is 3% by mass or more, preferably 4% by mass or more, and may be 5% by mass or more. The content of the Si-containing material in the negative electrode active material is, for example, 15% by mass or less, and may be 10% by mass or less. A combination of any of the upper limits and any of the lower limits is possible.

The negative electrode mixture may contain a conductive agent. Examples of the conductive agent include conductive fibers and conductive particles. Examples of the conductive fibers include carbon fibers and metal fibers. The carbon fibers include carbon nanotubes (CNT). Examples of the conductive particles include conductive carbon (such as carbon black) and metal powders. One conductive agent may be used alone, or two or more conductive agents may be used in combination.

### (Positive Electrode)

The positive electrode may include a positive electrode current collector and a positive electrode mixture layer formed on a surface of the positive electrode current collector. The positive electrode mixture layer can be formed by applying a positive electrode slurry of a positive electrode mixture dispersed in a dispersion medium to the surface of the positive electrode current collector, followed by drying. The dried coating film may be rolled if necessary.

The positive electrode current collector is constituted by a sheet-shaped conductive material. As the positive electrode current collector, a non-perforated conductive substrate or metal foil may be used, for example. Alternatively, a perforated conductive substrate (such as a mesh, a net, or a punched sheet) may be used. Examples of the material of the positive electrode current collector include stainless steel, aluminum, aluminum alloys, and titanium. The thickness of the positive electrode current collector is, for example, 1 to 50 μm, and may be 5 to 30 μm.

The positive electrode mixture contains a positive electrode active material as an essential component, and may contain, for example, a binder and a conductive agent as optional components. As the dispersion medium, water, an alcohol (e.g., ethanol), an ether (e.g., tetrahydrofuran), an amide (e.g., dimethylformamide), N-methyl-2-pyrrolidone (NMP), or a mixed solvent of these may be used, for example.

As the positive electrode active material, a composite oxide containing lithium and a transition metal is used, for example. Examples of the transition metal include Ni, Co, and Mn. Examples of the composite oxide containing lithium and a transition metal include LiₐCoO₂, LiₐNiO₂, LiₐMnO₂, LiₐCo_{b1}Ni_{1-b1}O₂, LiₐCo_{b1}M_{1-b1}O_{c1}, LiₐNi_{1-b1}M_{b1}Oc₁, LiₐMn₂O₄, and LiₐMn_{2-b1}M_{b1}O₄. Here a=0 to 1.2, b1=0 to 0.9, and c1=2.0 to 2.3. M is at least one selected from the group consisting of Na. Mg, Sc. Y, Mn, Fe, Co, Ni, Cu, Zn, Al, Cr. Pb, Sb, and B. Note that the value a indicating the molar ratio of lithium increases and decreases with charging and discharging.

Among these, a lithium-nickel composite oxide represented by LiₐNi_{b2}M_{1-b2}O₂ (0<a≤1.2, 0.3≤b2≤1, and M is at least one selected from the group consisting of Mn, Co and Al) is preferable. In view of increasing the capacity, it is more preferable to satisfy 0.8≤b2≤1 or 0.85≤b2≤1. From the point of view of stability of the crystalline structure, LiₐNi_{b2}Co₂Al_{d}O₂ (0<a≤1.2.0.8≤b2<1.0<c2<0.2 (or 0<c2≤0.18), 0<d≤0.1, and b2+c2+d=1) is more preferable.

As the binder and the conductive agent, the materials exemplified as those for the negative electrode can be used, for example.

### (Separator)

Preferably, the separator is provided between the positive electrode and the negative electrode. The separator has high ion permeability and moderate mechanical strength and insulating properties. Examples of the separator include a microporous thin film, a woven fabric, and a nonwoven fabric. The separator may have a single-layer structure or a multilayer structure. The separator having a multilayer structure may be a laminate including, as layers, at least two selected from the group consisting of a microporous thin film, a woven fabric, and a nonwoven fabric. Preferably, the material of the separator is a polyolefin (e.g., polypropylene or polyethylene).

### (Nonaqueous Electrolyte)

The nonaqueous electrolyte is usually used in a liquid state, but may be in a state in which fluidity is restricted, for example, by a gelling agent, or may be a solid electrolyte. The liquid electrolyte (electrolyte solution) usually contains a nonaqueous solvent and a lithium salt dissolved in the nonaqueous solvent.

The gel-like electrolyte contains a lithium salt and a matrix polymer, or contains a lithium salt, a nonaqueous solvent, and a matrix polymer. As the matrix polymer, a polymer material that gels by absorbing a nonaqueous solvent is used, for example. Examples of the polymer material include fluorocarbon resin, acrylic resin, polyether resin, and polyethylene oxide.

The solid electrolyte may be an inorganic solid electrolyte. As the inorganic solid electrolyte, for example, a known material (e.g., an oxide-based solid electrolyte, a sulfide-based solid electrolyte, or a halide-based solid electrolyte) used in all-solid-state lithium-ion secondary batteries is used.

Examples of the nonaqueous solvent include cyclic carbonic acid esters, chain carbonic acid esters, cyclic carboxylic acid esters, and chain carboxylic acid esters. Examples of the cyclic carbonic acid esters include propylene carbonate (PC), ethylene carbonate (EC), fluoroethylene carbonate (FEC), and vinylene carbonate (VC). Examples of the chain carbonic acid esters include diethyl carbonate (DEC), ethyl methyl carbonate (EMC), and dimethyl carbonate (DMC). Examples of the cyclic carboxylic acid esters include γ-butyrolactone (GBL) and γ-valerolactone (GVL). Examples of the chain carboxylic acid esters include methyl formate, ethyl formate, propyl formate, methyl acetate (MA), ethyl acetate, propyl acetate, methyl propionate, ethyl propionate, and propyl propionate. The nonaqueous electrolyte may contain one nonaqueous solvent, or may contain two or more nonaqueous solvents in combination.

Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylates, LiCl, LiBr, LiI, phosphates, borates, and imide salts. Examples of the phosphates include lithium difluorophosphate (LiPO₂F₂), lithium difluorobis(oxalato)phosphate (LiDFBOP), and lithium tetrafluoro (oxalato)phosphate. Examples of the borates include lithium bis(oxalato) borate (LiBOB) and lithium difluoro (oxalato) borate (LiDFOB). Examples of the imide salts include lithium bis(fluorosulfonyl)imide (LiN(FSO₂)₂), lithium bis(tifluoromethanesulfonyl)imide (LiN(CF₃SO₂)₂), lithium trifluoromethanesulfonyl nonafluorobutanesulfonyl imide (LiN(CF₃SO₂)(C₄F₉SO₂)), and lithium bis(pentafluoroethanesulfonyl)imide (C₂F₅SO₂)₂). The nonaqueous electrolyte may contain one lithium salt, or may contain two or more lithium salts in combination.

The concentration of the lithium salt in the nonaqueous electrolyte is 0.5 mol/L or more and 2 mol/L or less, for example.

One example of the configuration of the nonaqueous electrolyte secondary battery is a configuration in which an electrode group in which the positive electrode and the negative electrode are wound with the separator therebetween is housed in an exterior body together with the nonaqueous electrolyte. However, the configuration of the nonaqueous electrolyte secondary battery is not limited to the configuration such as above. For example, the electrode group may be of stacked type in which the positive electrode and the negative electrode are stacked with the separator therebetween. The form of the nonaqueous electrolyte secondary battery is also not limited, and may be, a cylindrical, prismatic, coin-shaped, button-shaped, or laminated, for example.

FIG. 1 is a partially cut-away perspective view of a prismatic nonaqueous electrolyte secondary battery according to an embodiment of the present disclosure. The nonaqueous electrolyte secondary battery includes a bottomed prismatic battery case 4, and an electrode group 1 and an electrolyte (not illustrated) housed in the battery case 4. The electrode group 1 includes a long strip-shaped negative electrode, a long strip-shaped positive electrode, and a separator provided therebetween. The negative electrode current collector of the negative electrode is electrically connected to a negative electrode terminal 6 provided at a sealing plate 5 via a negative electrode lead 3. The negative electrode terminal 6 is insulated from the sealing plate 5 by a resin-made gasket 7. The positive electrode current collector of the positive electrode is electrically connected to the back surface of the sealing plate 5 via a positive electrode lead 2. That is, the positive electrode is electrically connected to the battery case 4 that serves also as a positive electrode terminal. The peripheral edge of the sealing plate 5 is fitted to the open end of the battery case 4, and the fitting portion is laser-welded. The sealing plate 5 has an injection hole for the electrolyte solution, and is closed with the sealing plug 8 after injection.

### <Supplemental Remarks>

According to the above description of the embodiment, the following techniques are disclosed.

### (Technique 1)

A nonaqueous electrolyte secondary battery including: a positive electrode; a negative electrode; a separator provided between the positive electrode and the negative electrode; and a nonaqueous electrolyte, wherein
the negative electrode includes a negative electrode current collector and a negative electrode mixture layer formed on a surface of the negative electrode current collector,
the negative electrode mixture layer contains a negative electrode active material, a first binder, and an isothiazolin-based compound,
the first binder is a carboxymethylcellulose compound, and
a proportion of a mass of the isothiazolin-based compound in the negative electrode mixture layer to a mass of the negative electrode mixture layer is 20 ppm or more and 2000 ppm or less.

### (Technique 2)

The nonaqueous electrolyte secondary battery according to Technique 1, wherein the proportion of the mass of the isothiazolin-based compound in the negative electrode mixture layer to the mass of the negative electrode mixture layer is 100 ppm or more and 1000 ppm or less.

### (Technique 3)

The nonaqueous electrolyte secondary battery according to Technique 1 or 2, the isothiazolin-based compound is at least one selected from the group consisting of 5-chloro-2-methyl-4-isothiazolin-3-one, 2-methyl-4-isothiazolin-3-one. 2-n-octyl-4-isothiazolin-3-one, 4,5-dichloro-2-n-octyl-4-isothiazolin-3-one, 2-ethyl-4-isothiazolin-3-one, 4,5-dichloro-2-cyclohexyl-4-isothiazolin-3-one, 5-chloro-2-ethyl-4-isothiazolin-3-one, 5-chloro-2-t-octyl-4-isothiazolin-3-one, and 1,2-benzothiazolin-3-one.

### (Technique 4)

The nonaqueous electrolyte secondary battery according to any one of Techniques 1 to 3, wherein a proportion of a mass of the carboxymethylcellulose compound in the negative electrode mixture layer to the mass of the negative electrode mixture layer is 0.2% by mass or more and 5.0% by mass or less.

### (Technique 5)

The nonaqueous electrolyte secondary battery according to any one of Techniques 1 to 4, wherein the negative electrode mixture layer contains a second binder different from the first binder, and
a proportion of a mass of the second binder in the negative electrode mixture layer to the mass of the negative electrode mixture layer is 10.0% by mass or less.

### (Technique 6)

A method of producing a nonaqueous electrolyte secondary battery including:
a step of preparing a positive electrode;
a step of preparing a negative electrode;
a step of preparing a separator;
a step of preparing a nonaqueous electrolyte;
a step of forming an electrode body with the positive electrode, the negative electrode, and the separator; and
a step of accommodating the electrode body and the nonaqueous electrolyte in a battery case, wherein
the step of preparing a negative electrode includes: a step of preparing a negative electrode slurry by mixing a negative electrode mixture and water, and a step of forming a negative electrode mixture layer by applying the negative electrode slurry to a surface of a negative electrode current collector to form a coating film, followed by crying the coating film and compressing the coating
the negative electrode mixture contains a negative electrode active material, a first binder, and an isothiazolin-based compound, and the first binder is a carboxymethylcellulose compound.

### (Technique 7)

The method of producing a nonaqueous electrolyte secondary battery according to Technique 6, wherein a proportion of a mass of the isothiazolin-based compound in the negative electrode slurry to a mass of the negative electrode slurry is 10 ppm or more and 1000 ppm or less.

### (Technique 8)

The method of producing a nonaqueous electrolyte secondary battery according to Technique 6 or 7, wherein a proportion of a mass of the isothiazolin-based compound in the negative electrode slurry to a mass of the negative electrode slurry is 50 ppm or more and 500 ppm or less.

### EXAMPLES

Hereinafter, the present invention will be described in detail based on examples and comparative examples. However, the present invention is not limited to the following examples.

### Examples 1 to 6 and Comparative Examples 1 and 2

Nonaqueous electrolyte secondary batteries were produced and evaluated by the following procedures.

### (1) Negative Electrode Production

Graphite having a cumulative 50% diameter (median diameter) of 22 μm based on volume-based particle size distribution was used as a negative electrode active material. Any of the following isothiazolin-based compounds was mixed with a negative electrode mixture containing the negative electrode active material, a sodium salt (CMC-Na) of CMC being a first binder, and SBR being a second binder in a mass ratio of 97.5:1.5:1.0 so that its mass content in the negative electrode mixture layer was as shown in Table 1. The resulting negative electrode mixture was dispersed in water (ion-exchanged water) to prepare a negative electrode slurry. The negative electrode slurry was applied to both surfaces of a long negative electrode current collector made of copper foil having a thickness of 8 μm by doctor blade coating. Thereafter, the resulting coating films were dried, and compressed using a roller. Thus, negative electrodes each having a negative electrode mixture layer on both surfaces of the negative electrode current collector were obtained. The negative electrodes were cut to a predetermined electrode size.

### <Isothiazolin-Based Compounds>

MI: 2-methyl-4-isothiazolin-3-one
CMI: 5-chloro-2-methyl-4-isothiazolin-3-one
OIT: 2-n-octyl-4-isothiazolin-3-one
BIT: 1,2-benzothiazolin-3-one
DCOIT: 4,5-dichloro-2-n-octyl-4-isothiazolin-3-one

### (2) Positive Electrode Production

As a positive electrode active material, a lithium-containing metal composite oxide represented by LiC_{0.979}Zr_{0.001}Mg_{0.01}Al_{0.02}O₂ was used. The positive electrode active material, carbon black, and polyvinylidene fluoride (PVdF) were mixed in a mass ratio of 95:2.5:2.5 to prepare a positive electrode slurry containing N-methyl-2-pyrrolidone (NMP) as a dispersion medium. The positive electrode slurry was applied to both surfaces of a long positive electrode current collector made of aluminum foil having a thickness of 15 μm by doctor blade coating. Thereafter, the resulting coating film was dried, and compressed using a roller. Thus, a positive electrode including a positive electrode mixture layer on both surfaces of the positive electrode current collector was obtained. The positive electrode was cut to an electrode size.

### (3) Nonaqueous Electrolyte Preparation

To a mixed solvent obtained by mixing ethylene carbonate (EC) and methyl ethyl carbonate (MEC) in a volume ratio of 3:7 (25° C., 1 atm), LiPF₆ was dissolved at a concentration of 1 mol/L. Vinylene carbonate was further mixed so that the concentration of the vinylene carbonate became 2.0% by mass. Thus, a nonaqueous electrolyte was prepared.

### (4) Evaluation of Liquid Absorption

With respect to each of the produced negative electrodes, 3 μm of propylene carbonate (PC) was dropped onto the negative electrode mixture layer of the negative electrode. The time until the PC was absorbed into the negative electrode mixture layer and disappeared from the surface of the negative electrode mixture layer after the dropping was measured. In this evaluation, the liquid absorption time of Comparative Example 1 was used as a reference. That is. Table 1 shows the relative values each obtained by dividing the liquid absorption time measured for a corresponding one of Examples and Comparative Example by the liquid absorption time of Comparative Example 1.

(Liquid absorption time (%) of any of Examples and Comparative Example)=(Liquid absorption time of corresponding one of Examples and Comparative Example)×100/(Liquid absorption time of Comparative Example 1).

### (5) Evaluation of Adhesiveness Between Negative Electrode Mixture Layer and Negative Electrode Current Collector

With respect to each of the produced negative electrodes, peel strength of the negative electrode mixture layer of the negative electrode was measured in a manner that double-sided tape was attached to the negative electrode mixture layer of the produced negative electrode and the double-sided tape was pulled in a direction perpendicular to the negative electrode mixture layer at a speed of 100 mm/min until the negative electrode mixture layer was peeled off (see Japanese Laid-Open Patent Publication No. 2005-251481). In this evaluation, the peel strength of Comparative Example 1 was used as a reference. That is, Table 1 shows the relative values each obtained by dividing the peel strength measured for a corresponding one of Examples and Comparative Example by the peel strength of Comparative Example 1.

(Peel strength (%) of any of Examples and Comparative Example)=(Peel strength of corresponding one of Examples and Comparative Example)×100/(Peel strength of Comparative Example 1)

### (6) Battery Production

A positive electrode lead and a negative electrode lead were attached to the positive electrode and the negative electrodes, respectively, and the positive electrode and the negative electrode were wound via a separator of a microporous film made of polyethylene to obtain a wound body. After tape made of polypropylene was attached to the outermost peripheral surface of the wound body, the wound body was pressed in its radial direction to produce a flat wound electrode body. In an argon atmosphere, the electrode body and the nonaqueous electrolyte were accommodated in a cup-shaped accommodation part of an exterior body constituted by a laminate sheet having a five-layer structure of a polypropylene layer, an adhesive layer, an aluminum alloy layer, an adhesive layer, and a polypropylene layer. Thereafter, the electrode body was impregnated with the nonaqueous electrolyte by reducing the internal pressure of the exterior body, and the opening of the exterior body was then sealed. Thus, nonaqueous electrolyte secondary batteries having a height of 62 mm, a width of 35 mm, and a thickness of 3.6 mm were produced.

### (7) Evaluation of Rapid Charge and Discharge Capacity

With respect to each of the batteries of Examples and Comparative Examples, the battery was charged at 25° C. at a constant current of 0.7 C until the battery voltage reached 4.2 V, and then charged at a constant voltage of 4.2 V until the current dropped to a cutoff of 40 mA. Thereafter, discharging was done at a constant current of 1.0 C until the battery voltage reached 2.75 V. The above charge and discharge cycle was repeated 300 cycles, and the rate (capacity retention rate) of the discharge capacity at the 300th cycle to the discharge capacity at the first cycle was determined. The capacity retention rate of each battery is shown in Table 1.

TABLE 1

| | Condition | | Result | | |
|---|---|---|---|---|---|
| | | Content in | | | Rapid charge- |
| | Isothi- | negative | | | discharge |
| | azolin- | electrode | | Liquid | capacity |
| | based | mixture | Peel | absorption | retention |
| | com- | layer | strength | time | rate |
| | pound | (ppm) | (%) | (%) | (%) |
| Example 1 | MI | 100 | 95 | 95 | 88 |
| Example 2 | MI | 1000 | 85 | 87 | 87 |
| Example 3 | MI | 2000 | 80 | 80 | 88 |
| Example 4 | CMI | 1000 | 83 | 89 | 87 |
| Example 5 | OIT | 1000 | 85 | 88 | 85 |
| Example 6 | BIT | 1000 | 85 | 89 | 86 |
| Example 7 | DCOIT | 1000 | 85 | 85 | 78 |
| Comparative | MI | <5 | 100 | 100 | 88 |
| Example 1 | | | | | |
| Comparative | MI | 5000 | 50 | 75 | 83 |
| Example 2 | | | | | |

As shown in Table 1, the liquid absorption time for the negative electrode mixture layer of each negative electrode containing the predetermined amount or more of an isothiazolin-based compound was significantly shorter than that for the negative electrode of Comparative Example 1 containing less than the predetermined amount of an isothiazolin-based compound.

In each of Examples 4 to 7 in which the type of the isothiazolin-based compound was changed, the liquid absorption time was shorter and the capacity retention rate in rapid charging and discharging was also higher than those of Comparative Example 1.

In Comparative Example 2 in which 5000 ppm of MI was contained in the negative electrode mixture layer, peel strength was significantly reduced, and the capacity retention rate in rapid charging and discharging was decreased, although the liquid absorption time was shorter than that of Comparative Example 1.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### INDUSTRIAL APPLICABILITY

The nonaqueous electrolyte secondary battery according to the present disclosure is useful as a main power supply of, for example, a mobile communication device or a portable electronic device. However, these are merely examples, and application of the nonaqueous electrolyte secondary battery is not limited thereto.

### REFERENCE SIGNS LIST

1: Electrode group
2: Positive electrode lead
3: Negative electrode lead
4: Battery case
5: Sealing plate
6: Negative electrode terminal
7: Gasket
8: Sealing plug

1. A nonaqueous electrolyte secondary battery comprising:
a positive electrode;
a negative electrode;
a separator provided between the positive electrode and the negative electrode; and
a nonaqueous electrolyte, wherein
the negative electrode includes a negative electrode current collector and a negative electrode mixture layer formed on a surface of the negative electrode current collector,
the negative electrode mixture layer contains a negative electrode active material, a first binder, and an isothiazolin-based compound,
the first binder is a carboxymethylcellulose compound, and
a proportion of a mass of the isothiazolin-based compound in the negative electrode mixture layer to a mass of the negative electrode mixture layer is 20 ppm or more and 2000 ppm or less.

2. The nonaqueous electrolyte secondary battery according to claim 1, wherein
the proportion of the mass of the isothiazolin-based compound in the negative electrode mixture layer to the mass of the negative electrode mixture layer is 100 ppm or more and 1000 ppm or less.

3. The nonaqueous electrolyte secondary battery according to claim 1, wherein
the isothiazolin-based compound is at least one selected from the group consisting of 5-chloro-2-methyl-4-isothiazolin-3-one, 2-methyl-4-isothiazolin-3-one, 2-n-octyl-4-isothiazolin-3-one, 4,5-dichloro-2-n-octyl-4-isothiazolin-3-one, 4,5-dichloro-2-cyclohexyl-4-isothiazolin-3-one, 5-chloro-2-ethyl-4-isothiazolin-3-one, 5-chloro-2-t-octyl-4-isothiazolin-3-one, and 1,2-benzothiazolin-3-one.

4. The nonaqueous electrolyte secondary battery according to claim 1, wherein
a proportion of a mass of the carboxymethylcellulose compound in the negative electrode mixture layer to the mass of the negative electrode mixture layer is 0.2% by mass or more and 5.0% by mass or less.

5. The nonaqueous electrolyte secondary battery according to claim 1, wherein
the negative electrode mixture layer contains a second binder different from the first binder, and
a proportion of a mass of the second binder in the negative electrode mixture layer to the mass of the negative electrode mixture layer is 10.0% by mass or less.

6. A method of producing a nonaqueous electrolyte secondary battery, comprising:
a step of preparing a positive electrode;
a step of preparing a negative electrode;
a step of preparing a separator;
a step of preparing a nonaqueous electrolyte;
a step of forming an electrode body with the positive electrode, the negative electrode, and the separator; and
a step of accommodating the electrode body and the nonaqueous electrolyte in a battery case, wherein
the step of preparing a negative electrode includes: a step of preparing a negative electrode slurry by mixing a negative electrode mixture and water; and a step of forming a negative electrode mixture layer by applying the negative electrode slurry to a surface of a negative electrode current collector to form a coating film, followed by drying the coating film and compressing the coating film,
the negative electrode mixture contains a negative electrode active material, a first binder, and an isothiazolin-based compound, and
the first binder is a carboxymethylcellulose compound.

7. The method of producing a nonaqueous electrolyte secondary battery according to claim 6, wherein
a proportion of a mass of the isothiazolin-based compound in the negative electrode slurry to a mass of the negative electrode slurry is 10 ppm or more and 1000 ppm or less.

8. The method of producing a nonaqueous electrolyte secondary battery according to claim 6, wherein
a proportion of a mass of the isothiazolin-based compound in the negative electrode slurry to a mass of the negative electrode slurry is 50 ppm or more and 500 ppm or less.
